(19) United States
(12) Patent Application Publication
(10) Pub. No.: US 2014/0297413 A1
(43) Pub. Date: Oct. 2, 2014

(54) System and Method for Promotion of Retail Items and Customer Transactions

(71) Applicants: Derek Jon Thomas, Salem, MA (US); Douglas Erickson, Salem, MA (US)

(72) Inventors: Derek Jon Thomas, Salem, MA (US); Douglas Erickson, Salem, MA (US)

(21) Appl. No.: 13/853,967

(22) Filed: Mar. 29, 2013

(51) Int. Cl. G06Q 30/02

(52) U.S. Cl. CPC G06Q 30/0258
USPC 705/14.56

(57) ABSTRACT

Disclosed is a retail imaging system comprising: a mobile communication device having an imaging lens, a retailer software application, and a wireless communication module; a support stand configured to secure and support the mobile communication device at a predetermined distance from a retail item; and a retail imaging server in wireless communication with the wireless communication module for receiving a digital retail image file from the mobile communication device.

### CROSS REFERENCE TO RELATED APPLICATION

The present application is a Continuation-in-Part of co-pending Utility patent application entitled “Illuminating Device for Close-up Photography,” filed 25 Jul. 2012 and assigned Ser. No. 13/558,311, incorporated herein by reference in its entirety.

### FIELD OF THE INVENTION

The present invention relates to a system and method for using softly lit stabilized digital images, and customer information, to assist in promoting and completing customer retail transactions.

### BACKGROUND OF THE INVENTION

With the current proliferation of SMARTPHONES and mobile digital imaging devices, a retail customer bringing an imaging a device on a shopping trip may desire to photograph a retail item of interest. However, overhead store lighting, such as fluorescent lights, do not allow for properly lit and diffused-light photography. Also, the imaging device may not compensate a captured digital image for the limited spectrum of illumination provided by fluorescent bulbs. In addition, the imaging device used by the retail customer may not be able to focus on the small retail item of interest, and the customer may induce camera shake to produce an undesirable image. Furthermore, lack of proper background and overhead photo setting will result in photos and retail items having shadows and reflections. These drawbacks provide no benefit for a retailer desiring to complete a sale if a customer acquires bad looking photos of a retail item with a SMARTPHONE or other mobile communication device.

A retail jeweler, in particular, would prefer that the retail customer not take pictures as the resulting images results may be of poor quality, making a small item of jewelry, for example, appear to be unattractive and undesirable and, thus, offers little or no benefit to the retailer or to the customer. The jeweler might be able to offer a catalog to the retail customer, but such catalogs are pricey and include more information than the customer is likely to review. Accordingly, even though the jeweler might offer the retail customer a catalog, it is unlikely that the retail customer would return to the same jewelry establishment, and might even discard the expensive catalog. The same retailer would prefer to give that customer a good photo, but would like to have that customer receive the photo via e-mail. In this way, customer-provided e-mail information is valuable for the retailer to have, for continued sales and for marketing efforts. Such on-line communication also allows the customer to share the photo with family and friends, or post to social media sites to help make a buying decision.

What is needed is a method for a retailer to provide product information and clear, well lit, magnified and stabilized pictures to a customer that would promote the retail item of interest to the customer, while at the same time being able to capture the personal contact information and personal demographics of an interested customer.

### BRIEF SUMMARY OF THE INVENTION

In one aspect of the present invention, a retail imaging system suitable for transmitting a digital image of a selected retail item to a customer comprises: a graphical user interface for acquiring the digital image, the graphical user interface including a retailer software application and a wireless communication module, the retailer software application functioning to produce a digital retail image file from the digital image; a support stand configured to secure and support the graphical user interface at a predetermined distance from the retail item when the graphical user interface acquires the digital image of the selected retail item; and a retail imaging server including a resident retail customer promotional software application, the resident retail customer promotional software application in wireless communication with the retailer software application for receiving the digital retail image file for subsequent transmittal to the customer as the digital image.

In another aspect of the present invention, a retail item imager suitable for obtaining a digital image of a selected retail item comprises: a graphical user interface including an imaging lens, an image sensor, a retailer software application, and a wireless communication module, the imaging lens functioning with the image sensor to acquire a digital image of the selected retail item, the retailer software application functioning to produce a digital retail image file from the digital image, the wireless communication module enabling said graphical user interface to communicate with at least one of the Internet or a cell tower; a support stand, the support stand including a support surface configured to support and retain the graphical user interface; a front leg attached to the support surface; a rear leg attached to the support surface, the rear leg and the front leg defining an opening therebetween, the opening sized and shaped to allow entry of a user hand; at least one light source attached to the support stand; and a retail imaging server in wireless communication with the graphical user interface via at least one of the Internet or cell tower for receiving the digital retail image file.

In still another aspect of the present invention, a method of a retailer promoting a retail transaction to a customer comprises: acquiring a digital image of a retail item in which the customer has expressed interest; producing a digital retail image file from the digital image; providing customer contact information to the retailer; converting the digital retail image file to a web page with the digital image, the web page further including retailer information; and transmitting the web page to a computing device accessible by the customer.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a retail imaging system in which a retailer can use digital imaging and Internet technology to promote customer purchases, in accordance with the present invention;

FIG. 2 is a cross sectional simplified diagrammatical view of a retail item imager including an imaging support stand, as used in the system of FIG. 1;

FIG. 3 is an isometric diagrammatical view of a support component for an imaging support stand, in accordance with the present invention;

FIG. 4 is an isometric translucent diagrammatical view of an imaging support stand assembly including the support component of FIG. 3, a lens holder, and a light diffuser assembly, in accordance with the present invention;

FIG. 5 is a top diagrammatical view of the lens holder of FIG. 4;

FIG. 6 is a top diagrammatical view of the light diffuser assembly of FIG. 4;

FIG. 7 is an isometric diagrammatical view of a support pad for the imaging support stand of FIG. 4;

FIG. 8 is an isometric diagrammatical view of a support frame mounted on the support pad of FIG. 7;

FIG. 9 is a flow diagram illustrating operation of the retail imaging system of FIG. 1;

FIG. 10 is a diagrammatical illustration of a GUI device capturing an image file of a retail item;

FIG. 11 is a diagrammatical illustration of the GUI device of FIG. 10 displaying a virtual keyboard for entering customer information;

FIG. 12 is a diagrammatical of a customer computer device displaying a received image of the retail item of FIG. 10; and

FIG. 13 is a diagrammatical of a retail terminal displaying a database customer information.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present invention provides for a system and method of using a photographic stand and “light diffuser assembly” in coordination with a graphic user interface (GUI), giving a user or retailer the ability to capture small items, such as jewelry or coins in a properly-lit photographic environment. This environment preferably includes optional diffused lighting, a means of stabilizing the imaging device, and an optional feature to obtain a magnified digital image. When a customer wants to take photos (i.e., digital images and digital image files) of a desired item of interest, the GUI captures the digital image, and the customer enters required information, such as an e-mail address. The photo(s) are then transmitted to the customer. The customer information, such as the e-mail address, customer demographics, and related picture(s) are stored in a database, accessible online or off. The retailer, or system administrator, can access and utilize the stored customer information for sales and marketing efforts.

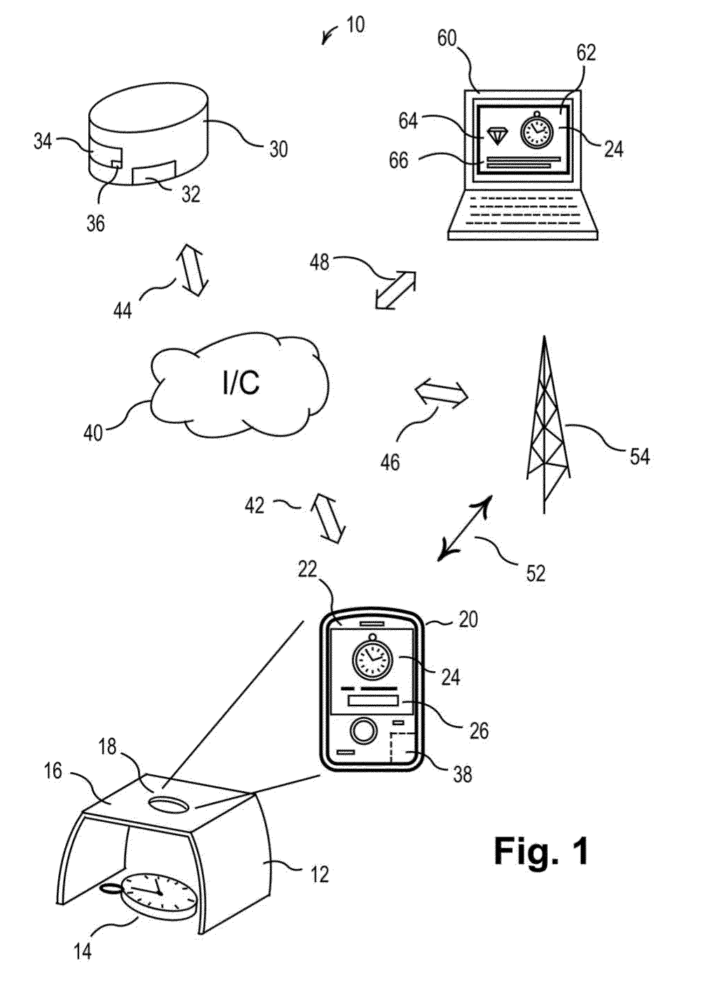

There is shown in FIG. 1 a retail imaging system 10 comprising a graphical user interface (GUI) device 20 positioned on an imaging support stand 12, the imaging support stand 12 preferably located in a retail establishment offering retail items for sale, such as, for example, a jewelry store selling jewelry items. The GUI device 20 has the capability of capturing a digital item image 24 of a retail item 14 selected by a customer patronizing the retail establishment. In an exemplary embodiment, the GUI device 20 may comprise a mobile communication device, such as a SMARTPHONE or an IPHONE for example, where the mobile communication device includes a built-in camera system and has Wi-Fi capabilities for connection to the Internet, as described in greater detail below. The GUI device 20 functions to optically capture and store a digitized item image of the retail item 14.

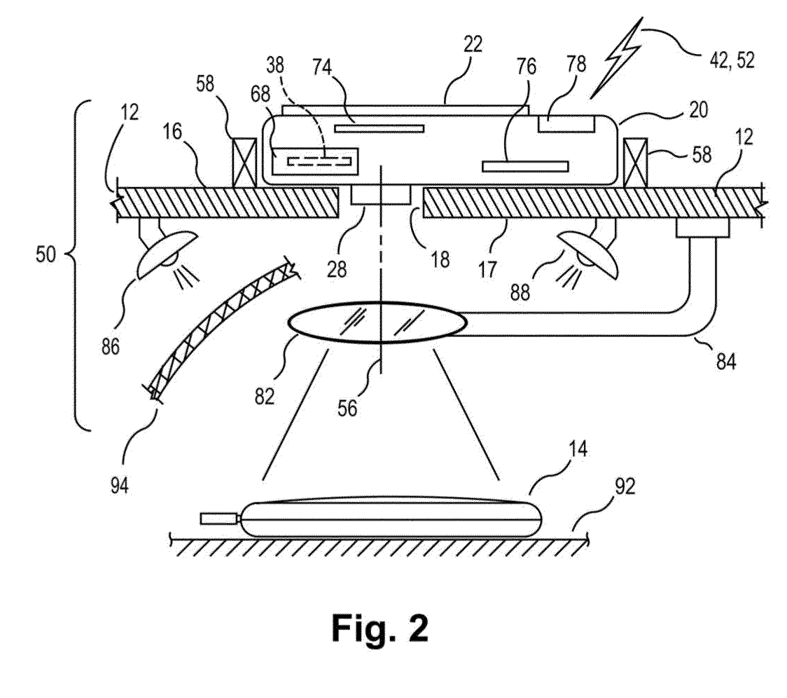

The GUI device 20 may be placed onto a support surface 16 of the imaging support stand 12 so as to position an imaging lens 28 (shown in FIG. 2) of the GUI device 20 over, or into, a lens window 18 in the support surface 16. The imaging support stand 12 functions to hold the GUI device 20 steady at a desired distance from the retail item 14 so as to enable the process of obtaining a clear digitized image free from blur. The imaging support stand 12 further functions as a light box for the purpose of providing optimal lighting conditions for obtaining the digitized images.

The retail item 14, here shown as a pocket watch, may be positioned under the support surface 16 so as to bring the retail item 14 into the field of view of the imaging lens 28. In the configuration shown, the digital item image 24 of the retail item 14 appears on a display screen 22 of the GUI device 20 to allow the retailer or the customer to move the retail item 14 about as desired, so as to optimally position the retail item 14 in the display screen 22. The digital item image 24 can thus be captured as the GUI device 20 is held on the support surface 16 at a fixed distance or height from the retail item 14. The display screen 22 may also include an interactive data entry field 26 in which the retailer or the customer can enter contact information such as, for example, an e-mail address.

The retail imaging system 10 further comprises a retail imaging server 30 for storing customer data related to the digital item image 24 in a retailer customer database 34. The GUI device 20 includes a retailer software application 38 that enables the GUI device 20 to communicate with the retail imaging server 30 via a server link 44 and the Internet/cloud 40. The retailer software application 38 also functions to convert the digital item image 24 to an image file 36. The image file 36 may be transmitted via the wireless link 42 from the GUI device 20 to the Internet 40, and then to the retail imaging server 30 via the server link 44.

Alternatively, the GUI device 20 may access a cell tower 54 via a cellular link 52, and the image file 36 may be transmitted to the retail imaging server 30 via a tower link 46 to the Internet/cloud 40. The retail imaging server 30 includes a retailer customer promotional software application 32 that functions: (i) to communicate with the retailer software application 38 in the GUI device 20, and (ii) to store the image file 36 in the retailer image database 34.

After the customer has left the retail establishment, or concurrently with the customer's visit, the retailer may send a web page 62 to the e-mail address previously provided to the retailer by the customer at the retail establishment. The customer may open the e-mail message and view the web page 62 using a computing device 60 in communication with the Internet/cloud 40 via an Internet link 48.

The web page 62 may include the digitized item image 24 of the retail item 14 previously viewed by the customer at the retail establishment offering the retail item 14 for sale. The web page 62 may also include a service mark or logo 64, used to identify the seller of the retail item 14, and may further include advertising or marketing information 66 selected by the retailer for transmittal to the customer. Such information may give the customer important contact information about the product, such as, for example, the name of the salesman, the stock number of the retail item, where the picture was taken, or other contact information.

Referring to FIG. 2, there is shown a diagrammatical side view of a retail item imager 50, including the imaging support stand 12 and the GUI device 20. The GUI device 20 is shown disposed on the imaging support stand 12 in accordance with the disclosed method of using the retail item imager 50. The GUI device 20 may be held in position by an enclosure frame 58. In the particular configuration shown, the imaging lens 28 protrudes into the lens window 18 so as to image the retail item 14 to the display screen 22 via an image sensor 74 for viewing by a user. It should be understood that in some imaging devices, the imaging lens 28 may be essentially flush with the front surface of the particular imaging device, and that, in such a case, the imaging lens 28 would not protrude into the lens window 18.

Images of the retail item 14 are obtained by the GUI device 20 via the image sensor 74 and may be stored in a memory 76, which may comprise an internal memory or a removable storage medium. As understood by one skilled in the relevant art, the image sensor 74 comprises an opto-electronic component that processes an optical image of the retail item 14 into an electronic signal that is further converted and stored in the memory 76 as a digital image file. In the present state of the art, the image sensor 74 may comprise a charge-coupled device (CCD) or a device having CMOS active pixel sensors.

A wireless communication module 78 may enable communication between the GUI device 20 and the Internet 40 via the wireless link 42, and/or may provide communication between the GUI device 20 and the cell tower 54 via the cellular link 52. The GUI device may also include the retailer software application 38 resident (optionally as a native app) in a retailer application software module 68. As explained above, the retailer software application 38 may function in conjunction with the wireless communication module 78 to control communication of the GUI device 20 with the retail imaging server 30.

As best seen in FIG. 2, a background material 92 may be provided under the retail item 14, and on a physical surface supporting the imaging support stand 12, such as the top of a commercial display cabinet or a table found in the retail establishment and designated for such purpose. The background material functions to visually set off the retail item 14 from the background in the acquired digital image. For example, the background material 92 may comprise black velvet to set off a metallic, or light-colored retail item in the acquired image. Conversely, the background material 92 may comprise a light-colored cardboard or plastic material to set off a dark retail item in the acquired image.

After the GUI device 20 has been positioned on the support surface 16, a close-up lens 82 may be brought into alignment with an optical axis 56 of the imaging lens 28 by rotating a lens support 84, here configured as a pivoting arm. The lens support 84 may be rotatably secured to an attachment surface 17 of the imaging support stand 12, substantially as shown. The close-up lens 82 allows for imaging relatively small items when the GUI device 20 does not have a close-focusing capability. In the present state of the art, by comparison, a separate macro photography lens designed for mobile devices needs to be attached to a lens for close-up imaging.

A first light source 86 and an optional second light source 88 may be used to provide illumination to the retail item 14. The first light source 86 and the optional second light source 88 may each comprise one or more light-emitting (LED) devices. The illumination thus provided may be diffused illumination, partially-diffused illumination, or non-diffused illumination, as may be desired by the retailer or customer. For example, a first light diffuser assembly 94 may be moved into place adjacent to the first light source. In an exemplary embodiment, the first light diffuser assembly 94 is disposed between the first light source 86 and the retail item 14 to provide some or all of the diffused lighting.

In an exemplary embodiment, the first light diffuser assembly 94 may be permanently fixed in position rather than be moveable by the user. The first light diffuser assembly 94 may comprise a translucent material, or may include a clear material having a “frosted” or an etched surface treatment so as to scatter incident light. In an exemplary embodiment, the first light source 86 and the second light source 88 may be secured to the attachment surface 17, substantially as shown.

In the example provided, the first light diffuser assembly 94 presents a cylindrically-convex surface to the first light source 86, although a different configuration can be used as well. For example, the first light diffuser assembly 94 may comprise a planar surface, a cylindrically-concave surface, a spherically-convex surface, or a spherically-concave surface. A second light diffuser assembly (not shown for clarity of illustration) may similarly be moved into place, or fixed in position, between the second light source 86 and the retail item 14 to provide additional diffused lighting. In an exemplary embodiment, the first light source 86 may be secured to the first light diffuser assembly 94 instead of to the attachment surface 17. It can be appreciated by one skilled in the art that, by using the imaging support stand 12, a customer can obtain an image of the retail item 14 which is not out of focus, not poorly lit, and not blurry as a result of camera movement.

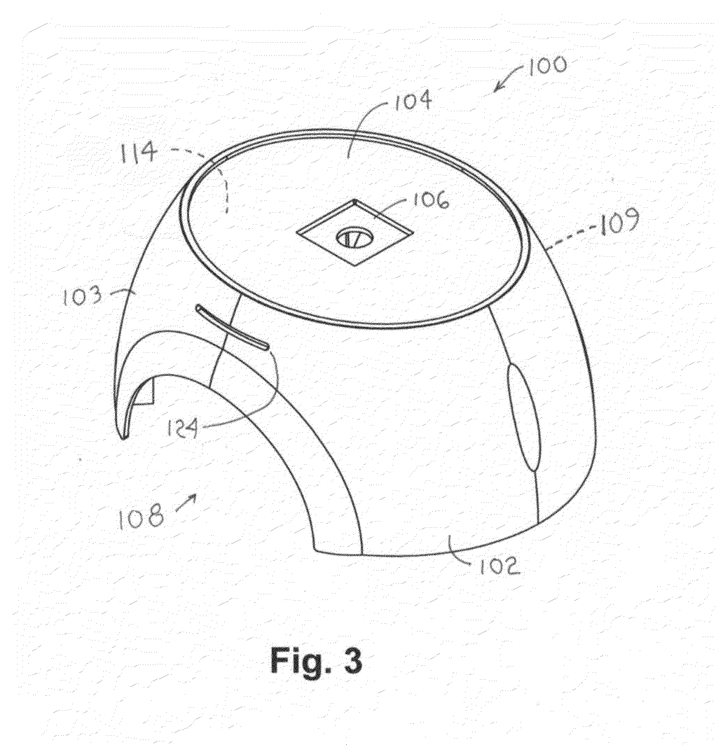

In an exemplary embodiment, shown in FIG. 3, a support component 100 for an imaging support stand includes a front arcuate leg 102, an opposed rear arcuate leg 103, a support surface 104, and an attachment surface 114 underlying the support surface 104 inside the support component 100. It can be appreciated by one skilled in the art that the front arcuate leg 102 and the rear arcuate leg 103 together function to physically support and stabilize the support surface 104 on a level, planar surface as may be provided in the retail establishment. A lens window 106 (i.e., a through hole) is typically provided in the support surface 104 extending through the support component 100 to the attachment surface 114. There may be provided an elongate slot 124 in the support component 100, to accommodate a protruding tab 122, as explained below.

The front arcuate leg 102 and the rear arcuate leg 103 may be substantially mirror images of one another, that is, forward and aft component parts. Accordingly, the support surface 104 remains substantially parallel to the physical support surface (not shown) upon which the front arcuate leg 102 and the rear arcuate leg 103 are placed. This feature serves to insure that the GUI device 20, or other imaging device placed on the support surface 104, is in proper optical alignment with respect to the retail item 14 when placed on the background material 92.

The geometric configuration of the front arcuate leg 102 disposed opposite the rear arcuate leg 103 thus defines an opening 108 therebetween on one side of the support component 100. The opening 108 is sized to allow a user to manually emplace an item of interest, such as the retail item 14 described above, using one hand. In an exemplary embodiment, this geometric configuration may similarly provide for an optional opening 109 (blocked from view in the illustration) at the other side of the support component 100 to allow the user to use both hands in emplacing the retail item 14.

It should be understood that the geometry of the front arcuate leg 102 and the rear arcuate leg 103 are not limited to an arcuate configuration, and that other shapes can be used for the support legs. Preferably, at least one opening, similar to the opening 108, is defined between the support legs of such other shapes so as to allow for entry of at least one user hand. In the illustration provided, the opening 108 comprises a substantially semicircular shape, but it can be appreciated that an opening of another shape can be provided in place of a semicircular opening, in accordance with the present invention. The support component 100 may be fabricated from an impact-resistant thermoplastic, such as acrylonitrile butadiene styrene (ABS) or similar plastic material.

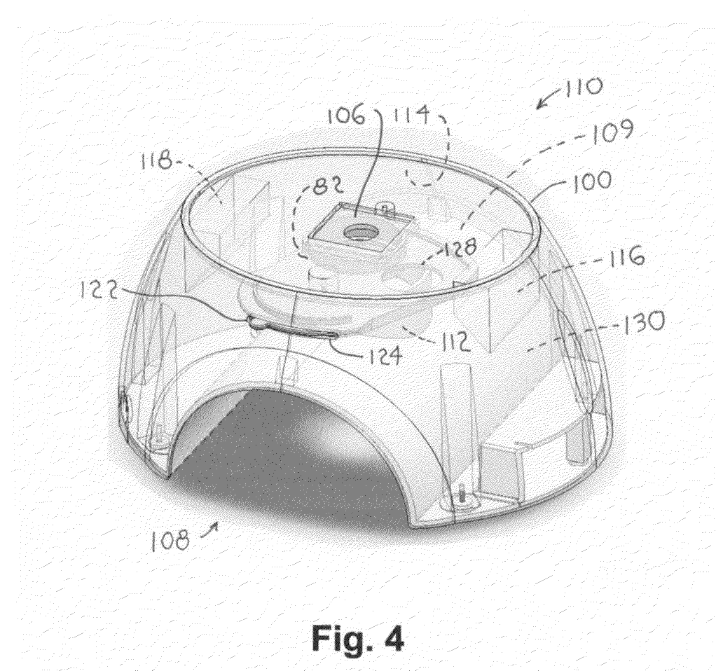

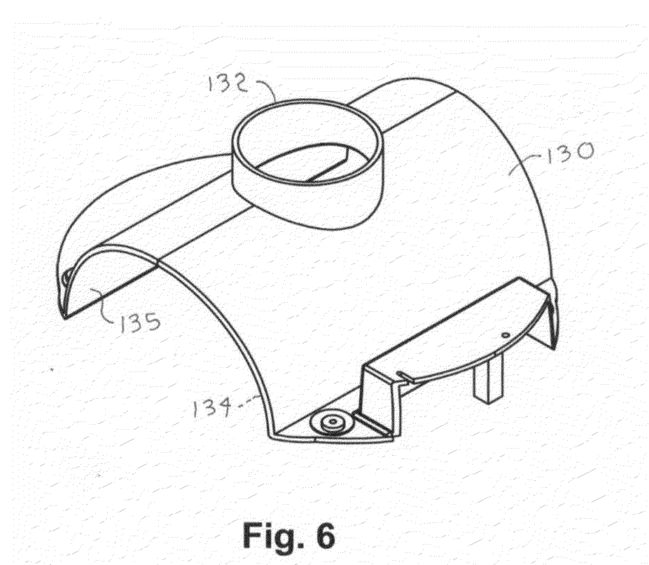

The support component 100 may be used as the exterior component of an imaging support stand 110, shown in FIG. 4. The imaging support stand 110 further comprises, inside the support component 100, a lens holder 112, a light diffuser assembly 130 (shown in FIG. 6), a first light source 116, and an optional second light source 118. One or both of the first light source 116 and the second light source 118 may be secured to the attachment surface 114, or may be secured to the light diffuser assembly 130.

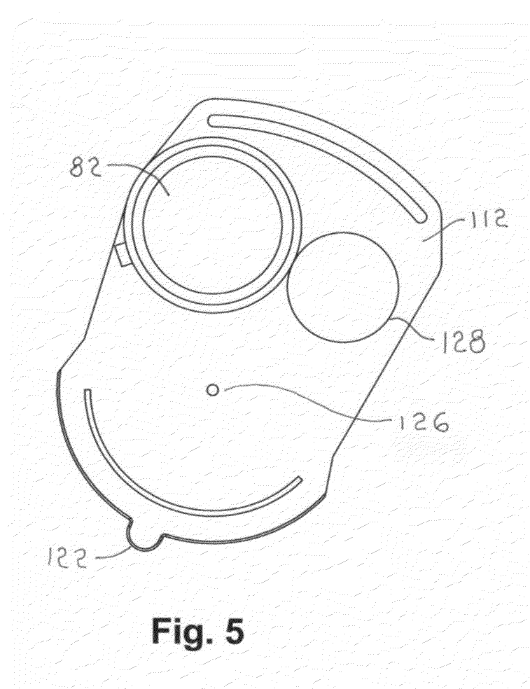

With additional reference to FIG. 5, the lens holder 112 comprises the close-up lens 82, the tab 122, an opening 128, and a pivot point 126. The lens holder 112 thus provides for a method of positioning the close-up lens 82 in or out of the optical axis 56 of the imaging lens 28 by appropriately moving the tab 122 within the slot 124 provided in the support component 100, as described above. That is, by selectively positioning the tab 122 along the slot 124, the user rotates the lens holder 112 about the pivot point 126 and places either the close-up lens 82 or the opening 128 into the optical axis 56.

As shown in FIG. 6, the light diffuser assembly 130 may include a turret opening 132 that is positioned under the lens window 106 of the support component 100 to block stray light from reaching the imaging lens 28. The light diffuser assembly 130 also includes a first side 134 and a second side 135, where both sides 134, 135 comprise a translucent or “frosted” material to diffuse the illumination provided by the first light source 116 and the second light source 118, respectively.

In the embodiment shown, the light diffuser assembly 130 comprises a generally cylindrically-convex shape sized and configured to fit under the support component 100 (shown in FIG. 4). The cylindrical shape further functions to provide space for the customer or the retailer to place the retail item 14 into position under the imaging lens 28 of the GUI device 12. In an alternative embodiment, the light diffuser assembly 130 may comprise any shape that serves to: (i) scatter incident light, and (ii) allow insertion of a user's hand(s) to emplace and position the retail item 14 for imaging.

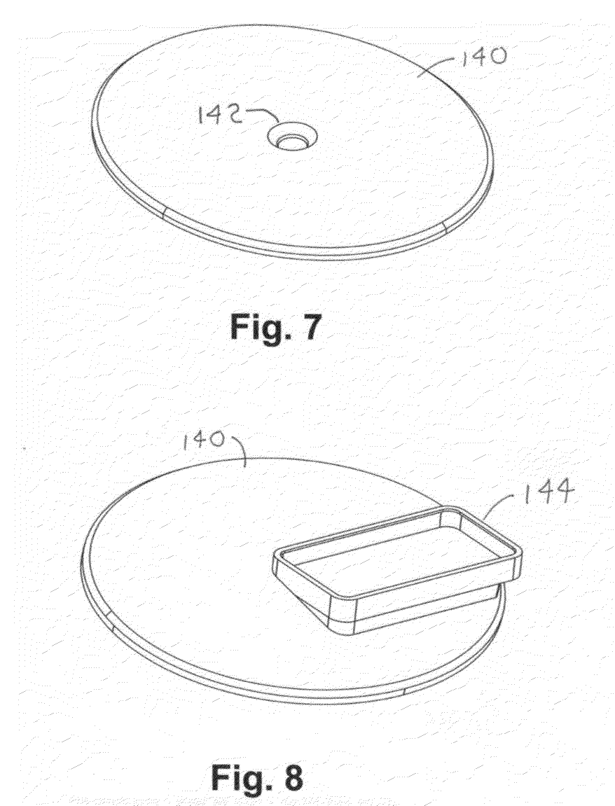

The imaging support stand 110 may also include an overlying pad 140, shown in FIG. 7. The pad 140 may be made from a soft, resilient material, and may be placed on the support surface 104 to provide cushioning for the GUI device 12. An opening 142 in the pad 140 is positioned over the lens window 106. In an exemplary embodiment, shown in FIG. 8, a frame enclosure 144 may be provided on the pad 140 to aid in positioning the imaging lens 28 of the GUI device 12 over the opening 142.

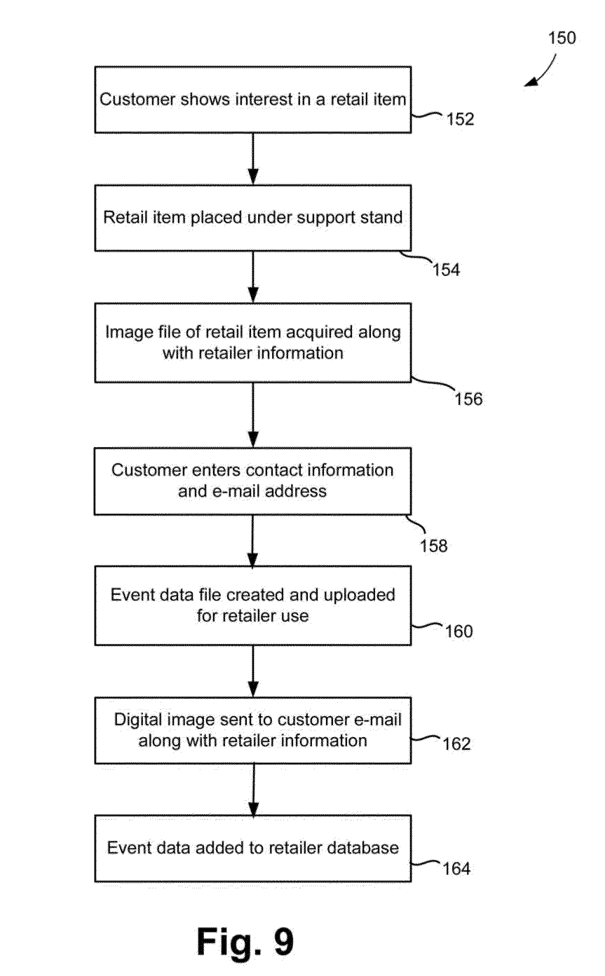

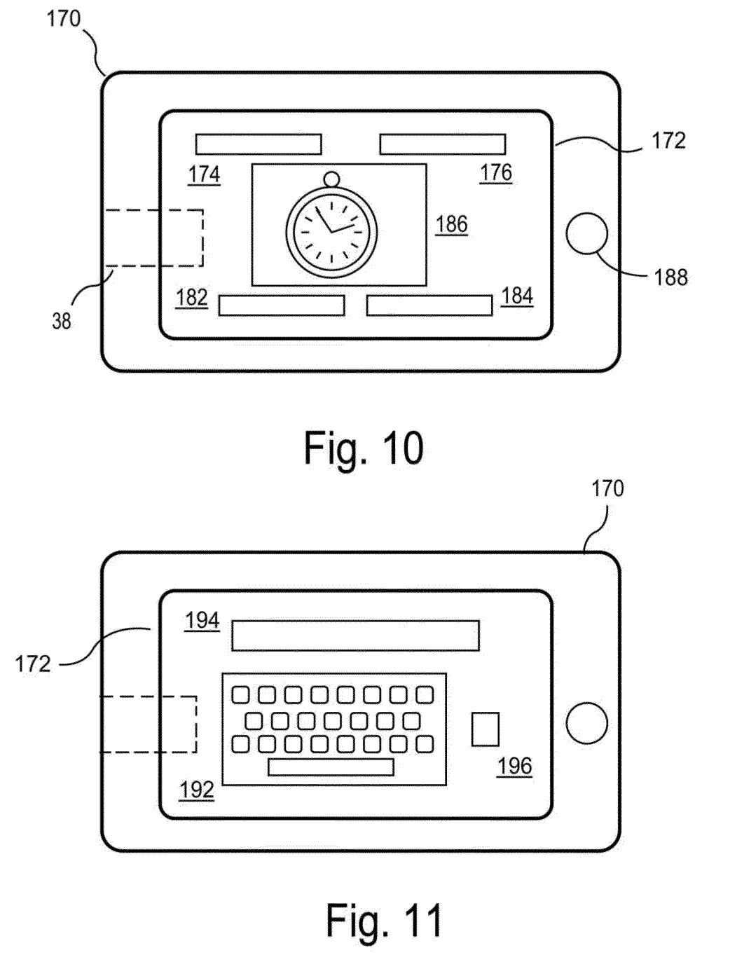

Operation of the retail imaging system 10 can be described with reference to a flow diagram 150 in FIG. 9 in which the customer visits a retail establishment and expresses an interest in a particular retail item 14, at step 152. The retail item 14 may then be placed under the imaging support stand 12, at step 154. A GUI device 170, shown in FIG. 10 as an IPHONE, images the retail item 14 onto a display screen 172 as a retail item image 186. The display screen 172 may also include information related to the retail establishment or store. For example, a first field 174 may display the name of the store, a second field 176 may display the store telephone number, a third field 182 may display a store logo, and a fourth field 184 may display the address or location of the store. In an exemplary embodiment, the screen of the GUI device 170 may show only the retail item image 186 on the display screen 172. The GUI device 170 may then capture a digital file of the retail item image 186 alone, and may then move to step 158.

When the customer is satisfied with the retail item image 186 on the display screen 172, a button 188 may be used or activated to acquire and store the retail item image 186 along with the information in the fields 174, 176, 182, 184, at step 156. The button 188 may be a physical button on the housing of the GUI device 170, as shown, or may be a virtual button (not shown) labeled as a “use” button or an “OK” button in the display screen 172. This action brings up a virtual keyboard 192 on the display screen 172, shown in FIG. 11, by which the customer can enter contact information, such as an e-mail address or a phone number, at step 158. It can be appreciated by one skilled in the art that having the e-mail address of such a prospective customer can be of value to a retailer.

A data entry field 194 may also be provided to display the contact information being entered. When all the information required of the customer has been entered, using an “enter” button 196, the retail item image 186, the information in the fields 174, 176, 182, 184, and the customer contact information may be saved as an event data file, at step 160, for subsequent use by the retailer.

When the event data file is created, the retailer software application 38 may function to save the retail item image 186 and the information in the fields 174, 176, 182, 184 in the retailer database 34. The web page 62 may be subsequently transmitted by the retailer customer promotional software 32 to the customer at the e-mail address previously entered into the data entry field 194, at step 164. This transmittal action may occur soon after the customer has “pressed” the ‘enter’ button 196, or may occur at a later time, as determined by the retailer and/or the retailer customer promotional software 32.

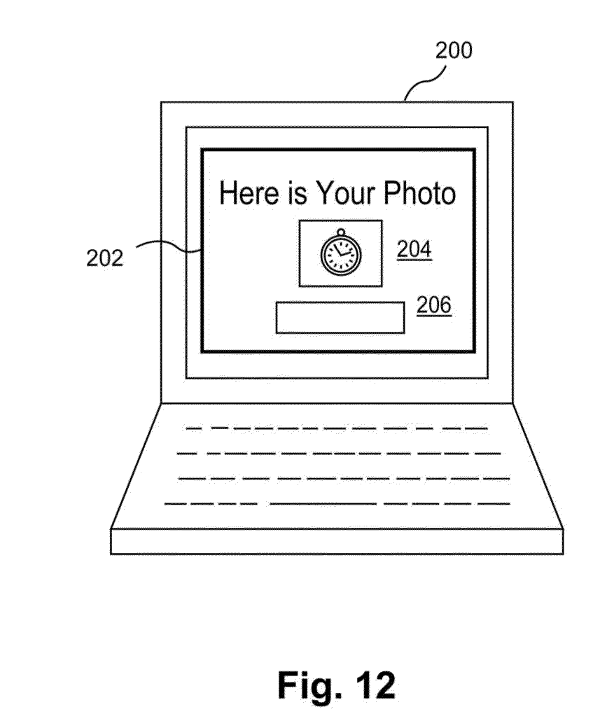

Accordingly, when the customer accesses the contact e-mail account using a computing device, such as a laptop computer 200, as shown in FIG. 12, a screen image 204 of the retail item 14 is provided on a display screen 202. In addition, there may be provided a window 206 displayed in the GUI device 20. The window 206 may include retailer information (e.g., the name of the retail establishment) related to the information previously viewed by the customer in the fields 174, 176, 182, 184.

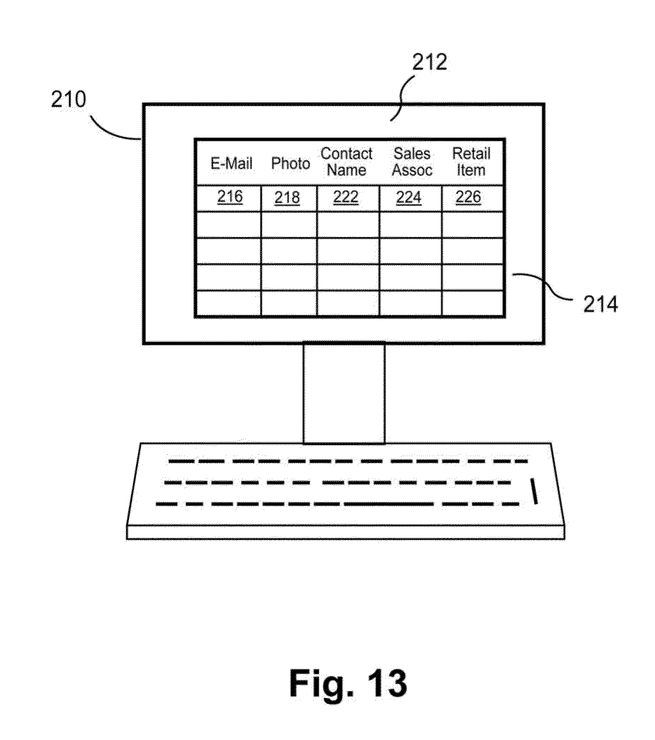

In addition, when the event data file is created, selected information from the event data file may be transmitted to a retailer database, at step 164, for retrieval as desired by the retailer in a format selected by the retailer. For example, the selected information may appear in a spreadsheet 214 that may be viewed on the display screen 212 of a retailer computing device, such as a computer 210 shown in FIG. 13.

In the example shown, the spreadsheet 214 includes a column 216 for listing customer e-mails, a column 218 for listing customer retail item photos, a column 222 for listing customer names, a column 224 for listing names of sales associates assisting the retail customers, and a column 226 listing identification data for the retail item appearing in column 218.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A retail imaging system suitable for transmitting a digital image of a selected retail item to a customer, said retail imaging system comprising:
a graphical user interface for acquiring the digital image, said graphical user interface including a retailer software application and a wireless communication module, said retailer software application functioning to produce a digital retail image file from the digital image;
a support stand configured to secure and support said graphical user interface at a predetermined distance from the retail item when said graphical user interface acquires the digital image of the selected retail item; and
a retail imaging server including a resident retail customer promotional software application, said resident retail customer promotional software application in wireless communication with said retailer software application for receiving said digital retail image file for subsequent transmittal to the customer as the digital image.

2. The retail imaging system of claim 1 wherein said graphical user interface further comprises an imaging lens and an image sensor, said imaging lens functioning with said image sensor to acquire the digital image of the selected retail item.

3. The retail imaging system of claim 1 wherein said resident retail customer promotional software application further functions to provide said digital retail image file as the digital image in a web page for transmittal to the customer, said web page including retailer information.

4. The retail imaging system of claim 1 wherein said support stand comprises an opening provided so as to allow manual placement of the retail item a predetermined distance from said graphical user interface.

5. The retail imaging system of claim 1 wherein said support stand comprises a lens window through hole positioned so as to enable said graphical user interface to acquire the digital image of the selected retail item.

6. The retail imaging system of claim 1 wherein said retail imaging server comprises a retailer database for storing said digital retail image file.

7. A retail item imager suitable for obtaining a digital image of a selected retail item, said retail item imager comprising:
a graphical user interface including an imaging lens, an image sensor, a retailer software application, and a wireless communication module, said imaging lens functioning with said image sensor to acquire a digital image of the selected retail item, said retailer software application functioning to produce a digital retail image file from said digital image, said wireless communication module enabling said graphical user interface to communicate with at least one of the Internet or a cell tower;
a support stand, said support stand including
a support surface configured to support and retain said graphical user interface;
a front leg attached to said support surface;
a rear leg attached to said support surface, said rear leg and said front leg defining an opening therebetween, said opening sized and shaped to allow entry of a user hand;
at least one light source attached to said support stand; and
a retail imaging server in wireless communication with said graphical user interface via said at least one of the Internet or a cell tower for receiving said digital retail image file.

8. The retail item imager of claim 7 wherein said support stand further comprises an attachment surface, said at least one light source attached to said attachment surface.

9. The retail item imager of claim 7 wherein said support stand further comprises a light diffuser assembly disposed proximate said at least one light source.

10. The retail item imager of claim 7 wherein said retailer software application functions to enable said graphical user interface to communicate with said retail imaging server.

11. The retail item imager of claim 7 further wherein said front leg and said rear leg each comprise an arcuate configuration whereby said opening is substantially semicircular.

12. The retail item imager of claim 7 wherein said support stand further comprises a frame enclosure to aid in positioning said graphical user interface on said support stand.

13. The retail item imager of claim 7 wherein said support stand further comprises a close-up lens mounted in a lens holder, said lens holder secured to said support stand at a pivot point for enabling selective positioning of said close-up lens between said graphical user interface and the selected retail item.

14. A method of a retailer promoting a retail transaction to a customer, said method comprising the steps of:
acquiring a digital image of a retail item in which the customer has expressed interest;
producing a digital retail image file from said digital image;
providing customer contact information to the retailer;
converting said digital retail image file to a web page with said digital image, said web page further including retailer information; and
transmitting said web page to a computing device accessible by the customer.

15. The method of claim 14 where said step of acquiring said digital image is performed in a retail establishment offering the retail item for sale.

16. The method of claim 14 further comprising the step of transmitting said digital retail image file to a retail imaging server for storage in a retailer database.

17. The method of claim 16 further comprising the step of converting said digital retail image file into a digital image in a spreadsheet, said spreadsheet for viewing on the display screen of a computing device accessible by the retailer.

18. The method of claim 14 wherein said step of acquiring a digital image comprises the step of using a graphical user interface, said graphical user interface including an imaging lens, an image sensor, and a display screen.

19. The method of claim 18 wherein said step of providing customer contact information comprises the step of entering data in a data entry field in said display screen.

20. The method of claim 14 wherein said step of converting said digital retail image file to a web page with said digital image comprises the step of providing said digital retail image file to a retail customer promotional software application resident in a retail imaging server.
